(19) United States
(12) Patent Application Publication
(10) Pub. No.: US 2020/0298588 A1
(43) Pub. Date: Sep. 24, 2020

(54) THERMAL PRINT HEAD AND THERMAL PRINTER

(71) Applicant: TOSHIBA HOKUTO ELECTRONICS CORPORATION, Asahikawa-Shi (JP)

(72) Inventors: Megumi YAMAUCHI, Asahikawa (JP); Takuji TSUNOO, Yokohama (JP); Masakatsu DOI, Asahikawa (JP); Masanori UCHITSUBO, Higashikagura (JP)

(73) Assignee: TOSHIBA HOKUTO ELECTRONICS CORPORATION, Asahikawa-Shi (JP)

(21) Appl. No.: 16/793,317

(22) Filed: Feb. 18, 2020

(30) Foreign Application Priority Data
Mar. 19, 2019 (JP) 2019-050956

(51) Int. Cl. B41J 2/335

(52) U.S. Cl. CPC B41J 2/3353; B41J 2/3351; B41J 2/33515

(57) ABSTRACT

Certain embodiments provide a thermal print head including: a first heat storage layer formed on a substrate; a heat generator formed on the first heat storage layer; an electrode formed from the first heat storage layer to the substrate and electrically connected to the heat generator; and a barrier layer that covers the electrode and is formed by a CVD method.

### CROSS-REFERENCE TO RELATED APPLICATIONS

This application is based upon and claims the benefit of priority from the prior Japanese Patent Application No. 2019-050956 filed in Japan on Mar. 19, 2019; the entire contents of which are incorporated herein by reference.

### FIELD

Embodiments described herein relate generally to a thermal print head and a thermal printer.

### BACKGROUND

A thermal print head is an output device that causes a resistor to generate heat and forms an image of a character, a figure, and the like on a thermal print medium and the like using the heat. The thermal print head is widely used in recording equipment, such as a barcode printer, a digital plate maker, a video printer, an imager, and a sticker printer.

In the thermal print head, a heat storage layer, a resistor layer, a conductor layer, and a protective film are disposed on a top surface of a ceramic substrate in this order. The resistor layer, the conductor layer, and the protective film are disposed from the heat storage layer over the top surface of the ceramic substrate. The top surface of the porous ceramic substrate includes fine depressed holes, unlike the surface of the heat storage layer formed of a glass and the like. Therefore, for example, when the resistor layer and the like are formed by a sputtering method, a layer formed on the top surface of the ceramic substrate and a layer formed on inner wall surfaces of the holes separately grow, thus possibly forming an interface between the layers and a crack on an edge between the top surface of the ceramic substrate and the inner wall surface of the hole.

When the protective film is formed along surfaces of the crack and the like formed on the resistor layer and the conductor layer, a loss, such as cracking, occurs also on the surface of the protective film. When the protective film is formed to cover the crack without being formed inside the gaps of the crack and the like of the resistor layer and the conductor layer, the protective film possibly peels off from the resistor layer and the conductor layer, or a loss, such as cracking, possibly occurs on the surface of the protective film.

When the peeling and the loss occur on the protective film, a corrosive substance, such as a sulfur component and a water content, in the air enters from the part, thus possibly causing corrosion and disconnection of the conductor layer forming an electrode. The corrosion and the disconnection of the conductor layer significantly occur at the proximity of the interface between the conductor layers and the crack.

The corrosion and the disconnection of the conductor layer occurred in the thermal print head, for example, degrade print quality or decrease a product lifetime of the thermal print head, thus reducing reliability of the thermal print head.

### BRIEF DESCRIPTION OF THE DRAWINGS

FIG. 1 is a top view of a thermal print head according to an embodiment;

FIG. 2 is a cross-sectional view of a head substrate according to the embodiment;

FIG. 3 is a top view of the head substrate according to the embodiment;

FIG. 4 is a cross-sectional view of a circuit substrate according to the embodiment;

FIG. 5 is a drawing describing a connection of the head substrate to the circuit substrate according to the embodiment;

FIG. 6 is a block diagram of a thermal printer according to the embodiment;

FIG. 7 is a cross-sectional view of the head substrate according to Modification 1;

FIG. 8 is a drawing describing an effect of a barrier layer;

FIG. 9 is a drawing describing the effect of the barrier layer;

FIG. 10 is a drawing describing the effect of the barrier layer; and

FIG. 11 is a drawing describing the effect of the barrier layer.

### DETAILED DESCRIPTION

Certain embodiments provide a thermal print head including: a first heat storage layer formed on a substrate; a heat generator formed on the first heat storage layer; an electrode formed from the first heat storage layer to the substrate and electrically connected to the heat generator; and a barrier layer that covers the electrode and is formed by a CVD method.

The following describes the embodiment of the present invention with reference to the drawings. The embodiment is an example, and the technical scope of the present invention is not limited to this. The drawings are schematically illustrated, and dimensions and the like are different from the actual dimensions and the like.

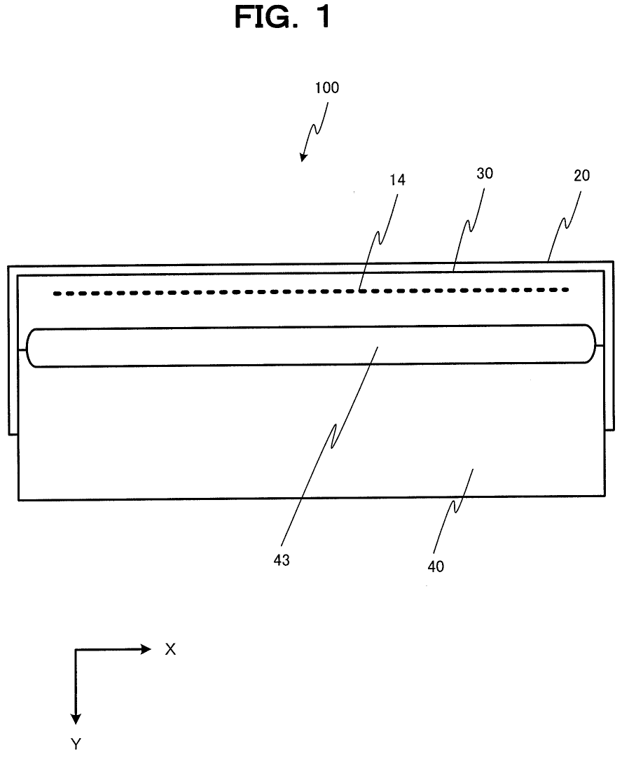

FIG. 1 is a top view of a thermal print head 100 according to the embodiment. As illustrated in FIG. 1, the thermal print head 100 includes a heatsink 20, a head substrate 30, and a circuit substrate 40. The head substrate 30 and the circuit substrate 40 are secured adjacent to one another to a principal surface of the heatsink 20 with an adhesive. For the adhesive, a double-sided adhesive tape and a thermosetting resin adhesive, such as a soft silicone resin, can be used. Here, in FIG. 1, a direction X is a main-scanning direction and a direction Y is a sub-scanning direction as a moving direction of a print medium.

The heatsink 20 is a flat plate formed of a metal having a high thermal conductivity, for example, aluminum.

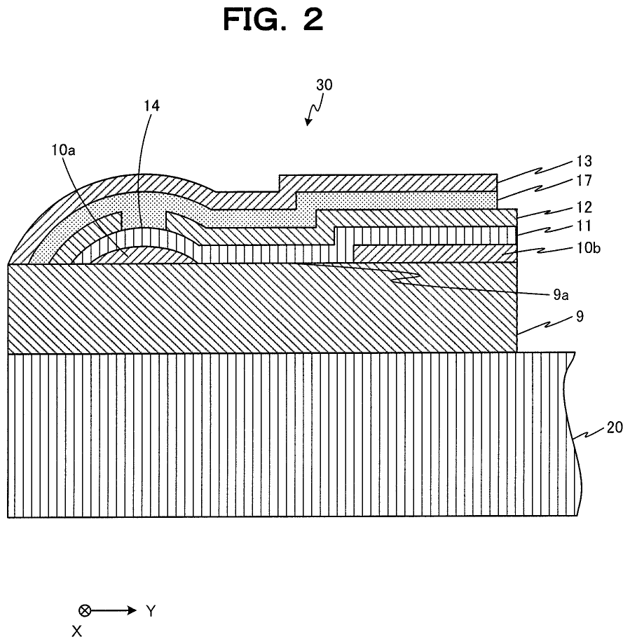

The head substrate 30 has a function of printing on a print medium. As illustrated in FIG. 1, the head substrate 30 is a member having the main-scanning direction X in a longitudinal direction. As illustrated in FIG. 2, the head substrate 30 includes a supporting substrate 9, a first heat storage layer 10a constituting a glaze layer, a second heat storage layer 10b, a resistor layer 11, a conductor layer 12, a barrier layer 17, and a protective film 13.

The supporting substrate 9 is formed of an insulator material having a heat resistance, and formed of a ceramic, such as alumina. The supporting substrate 9 may be SiN, SiC, quartz, AlN, or a fine ceramic containing Si, Al, O, N, and/or the like. The supporting substrate 9 is, for example, a rectangular flat plate having a plate thickness of about 0.5 mm to 1.0 mm. Since the supporting substrate 9 is formed of a porous ceramic, fine depressed holes are formed on a top surface 9a of the supporting substrate 9.

The first heat storage layer 10a and the second heat storage layer 10b are formed on the top surface 9a of the supporting substrate 9. The first heat storage layer 10a and the second heat storage layer 10b are formed of, for example, glass powders containing SiO₂. The first heat storage layer 10a is disposed limited to the proximity of a heat generator 14. The second heat storage layer 10b is disposed separated from the first heat storage layer 10a in the Y-axis direction. On top surfaces of the first heat storage layer 10a and the second heat storage layer 10b, fine depressed holes are not formed.

The resistor layer 11 is formed on the first heat storage layer 10a and the second heat storage layer 10b from the first heat storage layer 10a to the second heat storage layer 10b. The resistor layer 11 is formed of, for example, a TaSiO-based, a NbSiO-based, a TaSiNO-based, or a TiSiCO-based electric resistor material.

The conductor layer 12 is laminated to be formed on the resistor layer 11. The conductor layer 12 is formed containing a metal, such as Al, Cu, and an AlCu alloy, as a main material. The resistor layer 11 exposed from the conductor layer 12 functions as the heat generator 14.

The resistor layer 11 and the conductor layer 12 possibly have interfaces between the layers and cracks at the proximity of edges between the top surface 9a of the supporting substrate 9 and inner wall surfaces of the depressed holes formed on the top surface 9a.

The barrier layer 17 covers the resistor layer 11 and the conductor layer 12 formed from the first heat storage layer 10a to the second heat storage layer 10b. Gaps of the interfaces between the layers, the cracks, and the like formed on the top surfaces of the resistor layer 11 and the conductor layer 12 are filled with the barrier layer 17. On a top surface of the barrier layer 17, the interfaces between the layers and the cracks are not formed. The barrier layer 17 is, for example, formed of SiON by a chemical vapor deposition (CVD) method.

The protective film 13 is formed on the barrier layer 17. The protective film 13 is formed of a hard and fine insulator material having a high thermal conductivity, such as a SiO₂ film, a SiN film, a SiON film, and a SiC film. A material of the surface of the protective film 13 containing at least Si and carbon is preferable because the thermal conductivity increases.

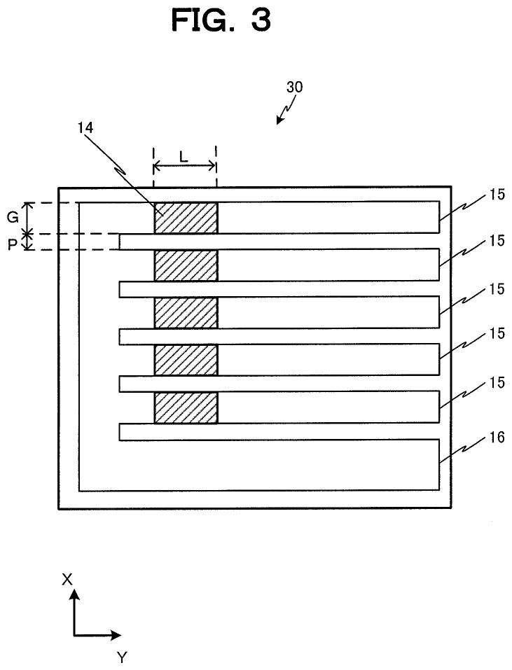

FIG. 3 is a top view of the head substrate 30 according to the embodiment. Hatched portions in FIG. 3 indicate the heat generators 14. As illustrated in FIG. 3, the heat generators 14 are formed in an array shape in the main-scanning direction X with pitches P. A pixel density (dot/inch) in printing on the print medium is determined depending on the areas of the heat generators 14 and the pitches P. The heat generators 14 have one ends connected to individual electrodes 15 and the other ends connected to a common electrode 16. The conductor layer 12 serves as the individual electrodes 15 and the common electrode 16 illustrated in FIG. 3. The individual electrodes 15 have widths G and are arranged having the pitches P. The width of the common electrode 16 may be larger than the widths of the individual electrodes 15.

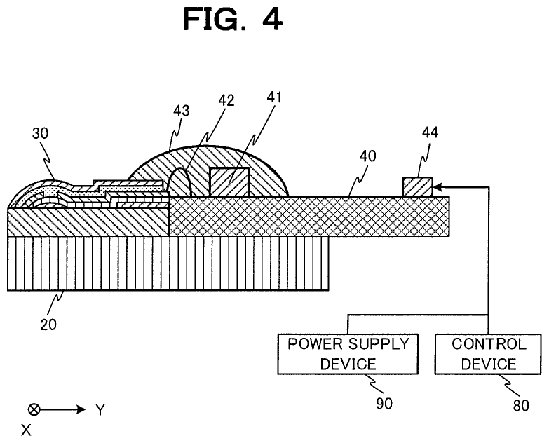

The circuit substrate 40 illustrated in FIG. 1 has a function to supply a current to the head substrate 30 based on a control of a control device 80 (not illustrated in FIG. 1). As illustrated in FIG. 4, the circuit substrate 40 is disposed on the principal surface of the heatsink 20 so as to be adjacent to the head substrate 30. The circuit substrate 40 is a substrate whose material is epoxy and the like, and a wiring whose material is copper is performed on the circuit substrate 40. A predetermined number of driving ICs 41 and connectors 44 are mounted to the circuit substrate 40.

The driving ICs 41 are mounted corresponding to the number of the heat generators 14 of the head substrate 30. The driving IC 41 is a control element having a switching function configured to control the current supplied to the heat generator 14. Specifically, the driving IC 41 controls the current supply from a power supply device 90 for each heat generator 14 of the head substrate 30 based on a control signal received from the control device 80 via the connector 44.

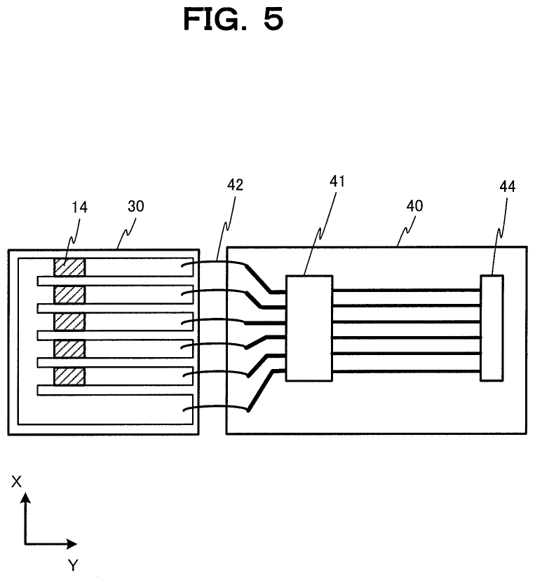

FIG. 5 is a drawing describing a connection of the head substrate 30 to the circuit substrate 40. The driving IC 41 includes output-side terminals electrically connected to the individual electrodes 15 and the common electrode 16 of the head substrate 30 via bonding wires 42.

As illustrated in FIG. 4, the driving IC 41 and the bonding wires 42 are sealed by a sealing material 43 formed of an epoxide-based resin. The sealing material 43 protects the bonding wires 42 and the driving IC 41 that connects the head substrate 30 to the circuit substrate 40. The sealing material 43 may also protect the individual electrodes 15 and the common electrode 16 of the head substrate 30, and a wiring part of the circuit substrate 40. While an epoxy resin coating material as a thermosetting resin is mainly used for the sealing material 43, a silicone resin having flexibility to some extent is used after thermosetting in some cases.

Here, a method for manufacturing the head substrate 30 will be described with reference to FIG. 2. The supporting substrate 9 in specified dimensions is prepared, and the first heat storage layer 10a and the second heat storage layer 10b formed of glass is formed on the top surface 9a of the supporting substrate 9. For the first heat storage layer 10a and the second heat storage layer 10b, for example, a glass paste in which a glass powder containing SiO₂ is mixed with an organic solvent is printed on the supporting substrate 9, and subsequently, sintering is performed to form the first heat storage layer 10a and the second heat storage layer 10b.

Subsequently, the resistor layer 11 and the conductor layer 12 are laminated in this order on the first heat storage layer 10a and the second heat storage layer 10b over the first heat storage layer 10a and the second heat storage layer 10b with a thin film forming apparatus, such as a sputtering apparatus.

Subsequently, etching removal of the conductor layer 12 is performed at the part on which the heat generator 14 is formed. In the example illustrated in FIG. 3, the etching removal of the conductor layer 12 is performed with a width G and a length L. The resistor layer 11 at the part on which the etching removal of the conductor layer 12 has been performed serves as the heat generator 14.

Subsequently, the barrier layer 17 that covers the individual electrodes 15, the common electrode 16, and the heat generators 14 is formed. For the barrier layer 17, for example, a film containing SiON is formed by the CVD method. The CVD method is one of the methods for synthesizing materials using a chemical reaction. The CVD method has various variations depending on chemical species to be supplied and required properties. For example, a heat CVD method, a catalyst chemical vapor deposition, a light CVD method, a plasma CVD method, an epitaxial CVD method, an atomic layer deposition, and a metal-organic vapor phase epitaxy are included. The heat CVD method and the plasma method, which use heat for controlling the chemical reaction, are used together in some cases.

As a characteristic of the CVD method, an advantage that film formation with a uniform thickness is ensured even on an uneven surface compared with a vacuum evaporation method, such as a Physical Vapor Deposition (PVD) method is provided. Accordingly, the barrier layer 17 is formed by covering the loss, such as the interfaces between the layers and the cracks, formed on the resistor layer 11 and the conductor layer 12. The loss, such as the interfaces, the cracks, and the like, is not generated on the top surface of the barrier layer 17.

Furthermore, the protective film 13 that covers the barrier layer 17 is formed. To connect the individual electrodes 15 and the common electrode 16 to the circuit substrate 40 by the bonding wires 42, openings are provided to the barrier layer 17 and the protective film 13 at positions corresponding to the individual electrodes 15 and the common electrode 16. The head substrate 30 is manufactured as described above.

Next, the performance of the head substrate 30 will be described. The head substrate 30 is supplied with a current between the individual electrodes 15 and the common electrode 16 based on the control by the circuit substrate 40. At a part where the resistor layer 11 contacts the conductor layer 12, since the current supplied from the circuit substrate 40 flows through the conductor layer 12 where a resistance is low, the resistor layer 11 does not generate heat. However, at a part where the conductor layer 12 has been etched away, since the current flows through the resistor layer 11 where the resistance is high, the resistor layer 11 generates heat. The resistor layer 11 at the part where the conductor layer 12 has been etched away functions as the heat generator 14.

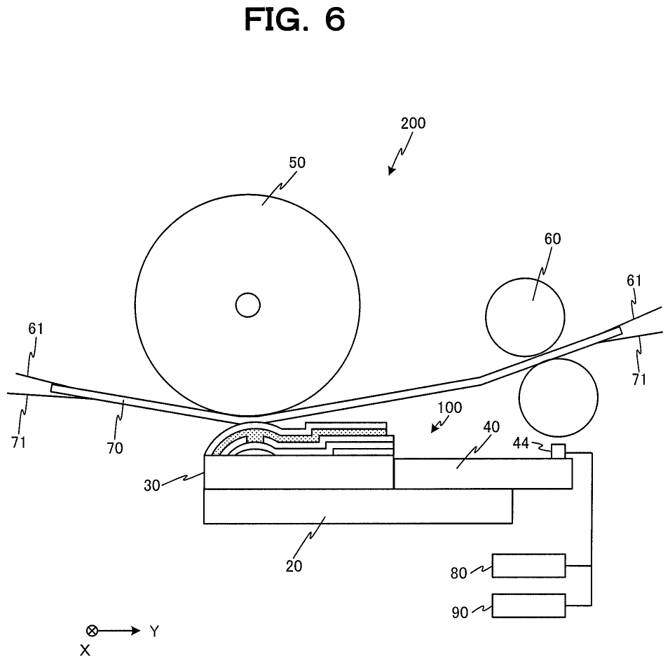

Next, a thermal printer 200 that includes the above-described thermal print head 100 will be described with reference to FIG. 6. FIG. 6 is a schematic block diagram of the thermal printer 200. As illustrated in FIG. 6, the thermal printer 200 includes the above-described thermal print head 100, a platen roller 50, and a conveyance mechanism 60.

The conveyance mechanism 60 conveys a print medium 70 and an ink ribbon 71 adhered to the print medium 70 using a conveyance medium 61 in the sub-scanning direction Y. The platen roller 50 presses the print medium 70 and the ink ribbon 71 onto the proximity of the heat generator 14 of the head substrate 30 together with the conveyance medium 61. The driving IC 41 of the circuit substrate 40 receives a control signal from the control device 80 and supplies a current from the power supply device 90 to the heat generators 14 corresponding to pixels of an image to be printed so as to cause the corresponding heat generators 14 to generate heat. The driving IC 41 controls On/Off of energization to the heat generators 14 at a high speed corresponding to a moving speed of the print medium 70 by the conveyance mechanism 60. The heat generator 14 generates heat while the current is supplied. An ink of the ink ribbon 71 pressed onto the head substrate 30 by the platen roller 50 melts only at a part positioned on the heat generator 14 during the heat generation, and adheres to the print medium 70.

The heat remaining after melting the ink of the ink ribbon 71 is radiated via the first heat storage layer 10a having a small thermal capacity, the supporting substrate 9, and the heatsink 20. Since the first heat storage layer 10a has the small thermal capacity, the temperature of the first heat storage layer 10a changes at high speed following the fast temperature change of the heat generator 14. When the first heat storage layer 10a keeps the high temperature state for a long time after the current supply to the heat generators 14 is stopped, the high temperature state continues also at the periphery of the heat generators 14 to which the current is not supplied. As a result, a blurred image is formed on the print medium 70. In the thermal print head 100 according to the embodiment, since the temperature of the first heat storage layer 10a changes at high speed following the fast temperature change of the heat generator 14, the thermal printer 200 can form a clear image on the print medium 70 during the fast movement of the print medium 70.

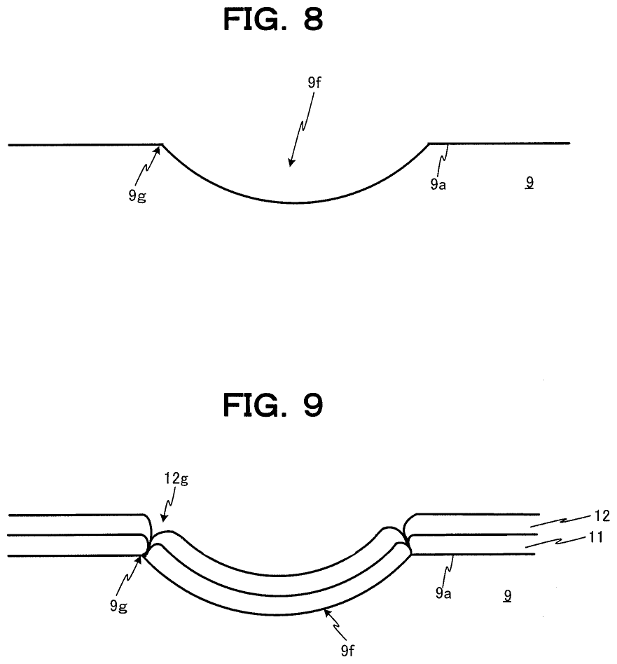

As described above, the thermal print head 100 according to the embodiment includes the barrier layer 17 formed by the CVD method, and the barrier layer 17 covers the electrodes formed on the top surface 9a of the supporting substrate 9 formed of a porous ceramic. As illustrated in FIG. 8, on the top surface 9a of the supporting substrate 9 formed of the porous ceramic, a fine depressed hole 9f is provided. Therefore, for example, when the resistor layer 11 and the like are formed by the sputtering method, as illustrated in FIG. 9, a layer formed on the top surface 9a of the supporting substrate 9 and a layer formed on an inner wall surface of the hole 9f separately grow, thus forming a loss 12g, such as an interface between the layers and a crack, on an edge 9g between the top surface 9a of the supporting substrate 9 and the inner wall surface of the hole 9f in some cases.

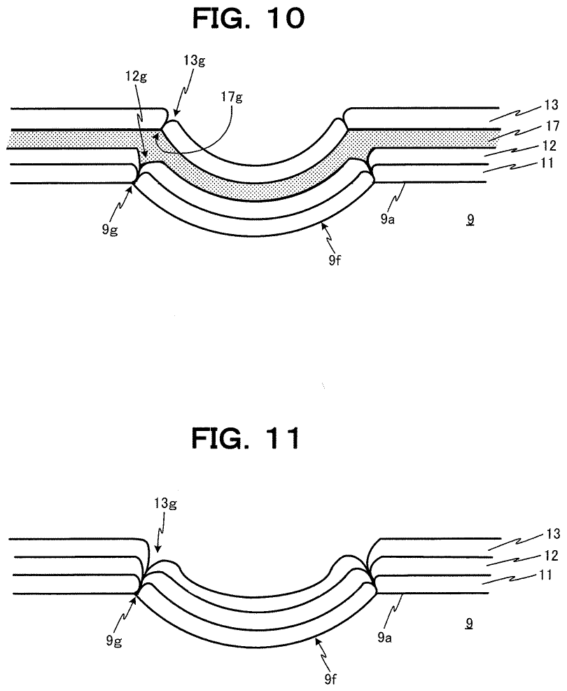

As illustrated in FIG. 10, since the barrier layer 17 formed by the CVD method is formed while filling the loss 12g, such as an interface between the layers and a crack, the loss does not occur on the barrier layer 17. Furthermore, the protective film 13 is formed on the barrier layer 17. Since the barrier layer 17 includes an edge 17g, the protective film 13 formed on the barrier layer 17 includes a loss 13g in some cases. However, a corrosive substance penetrated from the loss 13g is blocked by the barrier layer 17. Therefore, forming the barrier layer 17 ensures avoiding corrosion and disconnection of the conductor layer forming the electrodes due to the corrosive substance penetrated from the loss 13g. Accordingly, the reliability of the thermal print head can be improved.

Here, a case where the barrier layer 17 is not formed will be described. On the top surface 9a of the supporting substrate 9, the fine depressed hole 9f is provided. Therefore, as illustrated in FIG. 9, for example, when the resistor layer and the like are formed by the sputtering method, a film of the top surface 9a of the supporting substrate 9 and a film of the inner wall surface of the hole 9f separately grow, thus forming the loss 12g, such as an interface between the layers and a crack, on the edge 9g between the top surface 9a of the supporting substrate 9 and the inner wall surface of the hole 9f in some cases. When the protective film 13 is formed over the loss 12g by, for example, the sputtering method, as illustrated in FIG. 11, the loss 13g is easily generated also on the protective film 13. When a sulfur component and a water content in the atmosphere penetrate from the loss 13g, the conductor layer 12 forming the electrodes is corroded, thus possibly causing disconnection after the elapse of a long time.

Since the corrosion of the conductor layer 12 can be suppressed by disposing the barrier layer 17, the first heat storage layer 10a and the second heat storage layer 10b can be separately disposed. By disposing the first heat storage layer 10a limiting to the proximity of the heat generator 14, the thermal capacity of the first heat storage layer 10a can be decreased. Therefore, even when the heat generator 14 is turned On/Off at high speed, the temperature of the first heat storage layer 10a can be changed at high speed corresponding to the On/Off, and the temperature at the proximity of the heat generator 14 also changes at high speed corresponding to the control speed of the heat generator 14. Accordingly, the thermal responsiveness of the thermal print head 100 can be improved.

### Modification 1

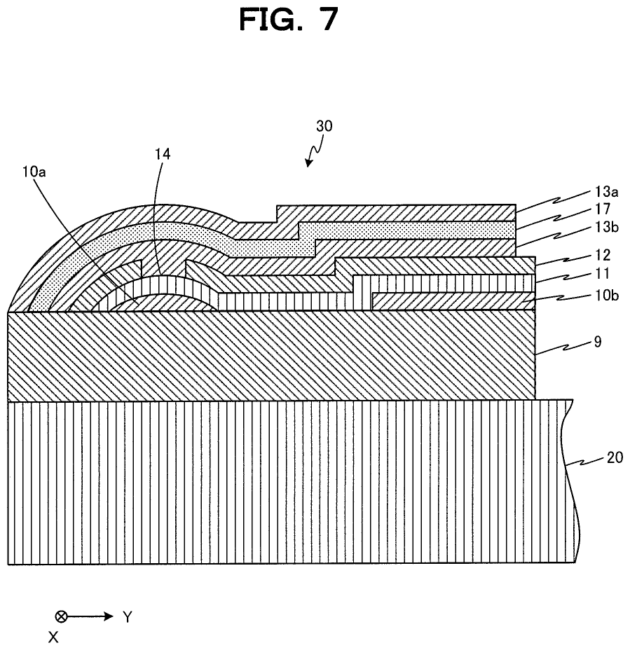

In the above-described description, as illustrated in FIG. 2, the case where the first heat storage layer 10a and the second heat storage layer 10b, the resistor layer 11, the conductor layer 12, the barrier layer 17, and the protective film 13 are formed in this order on the top surface 9a of the supporting substrate 9 is described. However, the layer configuration of the thermal print head 100 is not required to be limited to this. For example, as illustrated in FIG. 7, a second protective film 13b may be formed between the conductor layer 12 and the barrier layer 17. By disposing a first protective film 13a and the second protective film 13b, the durability of the thermal print head 100 can be further improved.

While, in the above-described description, the case where the barrier layer 17 is disposed also on the first heat storage layer 10a and the second heat storage layer 10b is described, the barrier layer 17 may be disposed only between the first heat storage layer 10a and the second heat storage layer 10b.

In the above-described description, the case where the head substrate 30 includes the first heat storage layer 10a and the second heat storage layer 10b is described. However, the number of the heat storage layers included in the head substrate is not required to be limited. For example, the number of the heat storage layers may be one, or three. When the three heat storage layers are disposed, the barrier layer may be disposed on a part other than the respective heat storage layers, or the barrier layer may be disposed over the respective heat storage layers.

While, in the above-described description, the case where the ink ribbon 71 is used for printing to the print medium 70 is described, the printing method is not required to be limited to this. For example, the print medium 70 may be a thermal paper. When the print medium 70 is the thermal paper, the pixels of the print medium 70 positioned on the heat generator 14 during the heat generation by the energization are colored through heat sensing.

While FIG. 5 illustrates the state where the driving IC 41 switches every wiring, the wiring pattern illustrated in FIG. 5 is one example, and it is not necessary to limit to this. For example, the common electrode 16 may be directly connected to the connector 44 without interposing the driving IC 41.

While FIG. 6 illustrates the state where the print medium 70 is continuously conveyed, the print medium 70 may include a plurality of separated print media. The material of the print medium 70 is various, for example, a paper, a plastic, a film, and a metal, and the material is not required to be limited.

According to the thermal print head according to at least one embodiment described above, since the thermal print head includes the barrier layer that covers the electrodes and is formed by the CVD method, the reliability of the thermal print head can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and sprit of the inventions.

What is claimed is:

1. A thermal print head comprising:
a first heat storage layer formed on a substrate;
a heat generator formed on the first heat storage layer;
an electrode formed from the first heat storage layer to the substrate and electrically connected to the heat generator; and
a barrier layer that covers the electrode and is formed by a CVD method.

2. The thermal print head according to claim 1, wherein
a protective film is formed on the barrier layer.

3. The thermal print head according to claim 1, wherein
a second protective film is formed between the electrode and the barrier layer.

4. A thermal print head comprising:
a first heat storage layer formed on a substrate;
a heat generator formed on the first heat storage layer;
a second heat storage layer formed on the substrate, and the second heat storage layer being formed separated from the first heat storage layer;
an electrode formed from the first heat storage layer to the second heat storage layer and electrically connected to the heat generator; and
a barrier layer that covers the electrode and is formed by a CVD method.

5. The thermal print head according to claim 4, wherein
a protective film is formed on the barrier layer.

6. The thermal print head according to claim 4, wherein
a second protective film is formed between the electrode and the barrier layer.

7. A thermal printer comprising:
a thermal print head that includes:
a first heat storage layer formed on a substrate;
a heat generator formed on the first heat storage layer;
an electrode formed from the first heat storage layer to the substrate and electrically connected to the heat generator; and
a barrier layer that covers the electrode and is formed by a CVD method;
a conveyance mechanism that conveys a print medium onto the heat generator included in the thermal print head; and
a platen roller that presses the print medium onto the heat generator.

8. The thermal printer according to claim 7, wherein
a protective film is formed on the barrier layer.

9. The thermal printer according to claim 7, wherein
a second protective film is formed between the electrode and the barrier layer.

10. A thermal printer comprising:
a thermal print head that includes:
a first heat storage layer formed on a substrate;
a heat generator formed on the first heat storage layer;
a second heat storage layer formed on the substrate, and the second heat storage layer being formed separated from the first heat storage layer;
an electrode formed from the first heat storage layer to the second heat storage layer and electrically connected to the heat generator; and
a barrier layer that covers the electrode and is formed by a CVD method;
a conveyance mechanism that conveys a print medium onto the heat generator included in the thermal print head; and
a platen roller that presses the print medium onto the heat generator.

11. The thermal printer according to claim 10, wherein
a protective film is formed on the barrier layer.

12. The thermal printer according to claim 10, wherein
a second protective film is formed between the electrode and the barrier layer.
